(19) United States
(12) Patent Application Publication
(10) Pub. No.: US 2025/0276693 A1
(43) Pub. Date: Sep. 4, 2025

(54) OBJECT RECOGNITION APPARATUS AND METHOD

(71) Applicants: Hyundai Motor Company, Seoul (KR); Kia Corporation, Seoul (KR)

(72) Inventor: En Sun Lee, Hwaseong-Si (KR)

(21) Appl. No.: 18/935,916

(22) Filed: Nov. 4, 2024

(30) Foreign Application Priority Data
Feb. 29, 2024 (KR) 10-2024-0029996

(51) Int. Cl. B60W 30/18; B60W 60/00

(52) U.S. Cl. CPC B60W 30/18163; B60W 60/001; B60W 2552/53; B60W 2554/20; B60W 2554/4041

(57) ABSTRACT

An apparatus for controlling autonomous driving of a vehicle is introduced. The apparatus may comprise a sensor and a processor configured to determine, based on the sensor sensing at least one of a lateral position of a point on a road boundary or a lateral position of at least one road structure, a merging of at least two different lanes, determine, based on at least one of a time period associated with the merging or a distance associated with the merging, a merging section, determine a type of an object located in the merging section, wherein the type is one of a moving object, a first stationary object that is able move, or a second stationary object that is unable move, and generate, based on the type, a control signal for controlling the autonomous driving of the vehicle in the merging section.

### CROSS-REFERENCE TO RELATED APPLICATION

This application claims the benefit of priority to Korean Patent Application No. 10-2024-0029996, filed in the Korean Intellectual Property Office on Feb. 29, 2024, the entire contents of which are incorporated herein by reference.

### TECHNICAL FIELD

The present disclosure relates to an object recognition apparatus and method, and more specifically, to a technology for identifying the characteristics of an object based on the positions of sensor points obtained through a sensor (e.g., light detection and ranging (LIDAR) sensor).

### BACKGROUND

A vehicle needs to be able to detect the vehicle's surrounding environment to react to unexpected situations and adjust its driving path without driver intervention.

The vehicle may obtain data indicating the position of an object around the vehicle through a sensor (e.g., LIDAR). A distance from a LIDAR to an object may be obtained through an interval between the time when laser is transmitted by the LIDAR and the time when the laser reflected by the object is received. The vehicle may identify the location of a point included outside of the object in a space where the vehicle is located, based on the angle of the transmitted laser and the distance to the object.

### SUMMARY

According to the present disclosure, an apparatus for controlling autonomous driving of a vehicle, the apparatus comprising a sensor and a processor, wherein the processor is configured to determine, based on the sensor sensing at least one of a lateral position of a point on a road boundary or a lateral position of at least one road structure, a merging of at least two different lanes; determine, based on at least one of a time period associated with the merging or a distance associated with the merging, a merging section associated with a risk of an accident; determine a type of an object located in the merging section, wherein the type is one of a moving object, a first stationary object that is able to be in a moving state, or a second stationary object that is unable to be in a moving state; and generate, based on the type of the object, a control signal for controlling the autonomous driving of the vehicle in the merging section.

The apparatus, wherein the processor is configured to determine the merging, based on at least one of: a difference between the lateral position of the point on the road boundary in a first frame, where the lateral position in the first frame corresponds to a longitudinal position of the vehicle in the first frame, and the lateral position of the point on the road boundary in a second frame, where the second frame is after the first frame; the lateral position of at least one road structure, where the road structure has a size smaller than a threshold size; or a longitudinal position of the at least one road structure, and where the lateral position of the point on the road boundary in the first frame is located in the same direction as the direction in which the lateral position of the point on the road boundary in the second frame is located, relative to the position of the vehicle.

The apparatus, wherein the processor is configured to: assign, based on the sensor sensing a width and a length of an object and based on the width being smaller than a threshold width and the length being smaller than a threshold length, a reliability value indicating that the type of the object is the moving object or the first stationary object; and determine, based on the reliability value, whether the type of the object is the moving object, the first stationary object, or the second stationary object.

The apparatus, wherein the processor is configured to determine the merging based on: a difference between the lateral position of the point on the road boundary in the first frame and the lateral position of the point on the road boundary in the second frame, where the lateral position in the second frame falls within a range, or a road boundary comprising the point on the road boundary in the first frame, where the road boundary is one of both lines of a lane in which the vehicle is located, and where the range is greater than the value of the width of one lane and smaller than the value of a width of a plurality of lanes.

The apparatus, wherein the processor is configured to determine the merging based on at least one of: a difference between the lateral position of the point on the road boundary in the first frame and the lateral position of at least one road structure, where the lateral position of the road structure is in the first frame and a lateral position value of the lateral position of the road structure in the first frame is less than a preset value, a maximum longitudinal position value of longitudinal position values of the road boundary at which the point on the road boundary is located, where the longitudinal position values of the road boundary are decreasing over time, or a minimum longitudinal position value of longitudinal position values of at least one road structure, where the longitudinal position values of the road structure are decreasing over time, where the road structure and the lateral position of the point on the road boundary in the first frame are located in the same direction as the direction in which the road structure is located, relative to the position of the vehicle, and where the road structure is located in the same direction as the direction in which the lateral position of the point on the road boundary in the first frame is located, relative to the position of the vehicle.

The apparatus, wherein the processor is configured to determine the merging based on a minimum longitudinal position value among longitudinal position values of at least one road structure, where the longitudinal position values of the road structure are decreasing over time, where the road structure is determined and the lateral position of the point on the road boundary in the first frame is not located in the same direction as the direction in which the road structure is located, relative to the position of the vehicle.

The apparatus, wherein the processor is configured to determine the merging based on a difference between a lateral position of a plurality of lateral positions of at least one road structure, where the lateral position of the road structure corresponds to the longitudinal position of the vehicle, and the lateral position of the point on the road boundary in the first frame, where the lateral position of the point on the road boundary in the first frame is located in the same direction as the direction in which the road structure is located, relative to the position of the vehicle, where the difference is greater than a threshold difference value, where the threshold difference value is preset based on a lane width, and where the road structure is determined.

The apparatus, wherein the processor is configured to: obtain a first time point at which the merging is determined; obtain a second time point at which the time period has been elapsed after a time point at which the at least one road structure is not determined; and determine, based on the time period, a region between: a line corresponding to the lateral position of the at least one road structure and a lateral position spaced apart from the line by a width of a lane, where the region is determined as the merging section.

The apparatus, wherein the processor is configured to: obtain a third time point at which the merging is determined; obtain a fourth time point at which the vehicle has traveled the distance; and determine, based on the third time point and the fourth time point, a region between: a line comprising the point on the road boundary in the first frame and a road boundary comprising the point on the road boundary in the second frame, where the region is determined as the merging section.

The apparatus, wherein the processor is configured to store, based on the object being in the merging section in the second frame, information in a third frame as history information.

The apparatus, wherein the processor is configured to determine the object as not being obscured by the at least one road structure, based on the object being located in the merging section and obscured by the at least one road structure.

The apparatus, wherein a reliability value, assigned to an object that is located in the merging section and has a width less than the threshold width and a length less than the threshold length, is larger than another reliability value assigned to a second object, wherein the second object is not located in the merging section or has a width greater than the threshold width or a length greater than the threshold length.

According to the present disclosure, a method performed by a processor for controlling autonomous driving of a vehicle, the method comprising determining, based on a sensor sensing at least one of a lateral position of a point on a road boundary or a lateral position of at least one road structure, a merging of at least two different lanes, determining, based on at least one of a time period associated with the merging or a distance associated with the merging, a merging section associated with a risk of an accident, determining a type of an object located in the merging section, wherein the type is one of a moving object, a first stationary object that is able to be in a moving state, or a second stationary object that is unable to be in a moving state, and generating, based on the type of the object, a control signal for controlling the autonomous driving of the vehicle in the merging section.

The method, wherein the determining the merging is based on the at least one of a difference between the lateral position of the point on the road boundary in a first frame, wherein the lateral position of the point on the road boundary in the first frame corresponds to a longitudinal position of the vehicle in the first frame, and the lateral position of the point on the road boundary in a second frame, wherein the second frame is after the first frame, the lateral position of the at least one road structure, wherein the at least one road structure has a size smaller than a threshold size, or a longitudinal position of the at least one road structure, and wherein the lateral position of the point on the road boundary in the first frame is located in a same direction as a direction in which the lateral position of the point on the road boundary in the second frame is located, relative to a position of the vehicle.

The method, wherein the determining the type of the object comprises assigning, based on the sensor sensing a width and a length of an object and based on the width being smaller than a threshold width and the length being smaller than a threshold length, a reliability value indicating that the type of the object is the moving object or the first stationary object, and determining, based on the reliability value, whether the type of the object is the moving object, the first stationary object, or the second stationary object.

The method, wherein the determining the merging is based on a difference between the lateral position of the point on the road boundary in the first frame and the lateral position of the point on the road boundary in the second frame, wherein the lateral position of the point on the road boundary in the second frame falls within a range, or a road boundary comprising the point on the road boundary in the first frame, wherein the road boundary comprising the point on the road boundary in the first frame is one of both lines of a lane in which the vehicle is located, and wherein the range is greater than a value of a width of one lane and smaller than a value of a width of a plurality of lanes.

The method, wherein the determining the merging is based on at least one of a difference between the lateral position of the point on the road boundary in the first frame and the lateral position of the at least one road structure, wherein the lateral position of the at least one road structure is in the first frame and a lateral position value of the lateral position of the at least one road structure in the first frame is less than a preset value, a maximum longitudinal position value of longitudinal position values of the road boundary at which the point on the road boundary is located, wherein the longitudinal position values of the road boundary are decreasing over time, or a minimum longitudinal position value of longitudinal position values of the at least one road structure, wherein the longitudinal position values of the at least one road structure are decreasing over time, wherein the at least one road structure and the lateral position of the point on the road boundary in the first frame are located in a same direction as a direction in which the at least one road structure is located, relative to the position of the vehicle, and wherein the at least one road structure is located in a same direction as a direction in which the lateral position of the point on the road boundary in the first frame is located, relative to the position of the vehicle.

The method, wherein the determining the merging is based on a minimum longitudinal position value among longitudinal position values of the at least one road structure, wherein the longitudinal position values of the at least one road structure are decreasing over time, wherein the at least one road structure is determined and the lateral position of the point on the road boundary in the first frame is not located in the same direction as the direction in which the at least one road structure is located, relative to the position of the vehicle.

The method, wherein the determining the merging is based on a difference between a lateral position a plurality of lateral positions of the at least one road structure, wherein the lateral position of the at least one road structure corresponds to the longitudinal position of the vehicle and the lateral position of the point on the road boundary in the first frame, wherein the lateral position of the point on the road boundary in the first frame is located in a same direction as a direction in which the at least one road structure is located, relative to the position of the vehicle, wherein the difference is greater than a threshold difference value, wherein the threshold difference value is preset based on a lane width, and wherein the at least one road structure is determined.

The method, wherein the determining the merging section comprises obtaining a first time point at which the merging is determined, obtaining a second time point at which the time period has been elapsed after a time point at which the at least one road structure is not determined, and determining, based on the time period, a region between a line corresponding to the lateral position of the at least one road structure and a lateral position spaced apart from the line by a width of a lane, wherein the region is determined as the merging section.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram showing an object recognition apparatus according to an example of the present disclosure;

FIG. 2 is a table showing information used to classify objects in an object recognition apparatus or an object recognition method according to an example of the present disclosure;

FIG. 3 illustrates a region in which the weights of reliability values are changed according to information related to an object recognition apparatus or an object recognition method according to an example of the present disclosure;

FIG. 4 shows an example of a lane in which a host vehicle is located in an object recognition apparatus or an object recognition method according to an example of the present disclosure;

FIG. 5 shows an example of merging of lanes identified according to changes in lateral position of points on a road boundary in an object recognition apparatus or an object recognition method according to an example of the present disclosure;

FIG. 6 shows an example of merging of lanes identified based on a point on a road boundary, and a road structure located at the point on the road boundary, in an object recognition apparatus or an object recognition method according to an example of the present disclosure;

FIG. 7 shows an example of merging of lanes identified based on a point on a road boundary, and a road structure spaced apart from a point on a road boundary, in an object recognition apparatus or an object recognition method according to one example of the present disclosure;

FIG. 8 shows an example of a merging section being identified according to a manner of identifying merging in an object recognition apparatus or an object recognition method, according to one example of the present disclosure;

FIG. 9 shows another example of a merging section being identified according to a manner of identifying merging in an object recognition apparatus or an object recognition method, according to one example of the present disclosure;

FIG. 10 shows an example of object identification by which an object is classified in an object recognition apparatus or an object recognition method according to an example of the present disclosure;

FIG. 11 shows an example of a flowchart of operation of an object recognition apparatus for classification and identification of an object in an object recognition apparatus or an object recognition method according to an example of the present disclosure;

FIG. 12 shows an example of object identification by a host vehicle located on a merging lane in an object recognition apparatus or an object recognition method according to an example of the present disclosure;

FIG. 13 shows an example of object identification by a host vehicle located on a merging lane in an object recognition apparatus or an object recognition method, according to one example of the present disclosure;

FIG. 14 shows an example of determination of a merging section by a host vehicle located on a lane that is the subject of merging in an object recognition apparatus or an object recognition method, according to one example of the present disclosure;

FIG. 15 shows an example of object identification in which an object is identified as a moving object in an object recognition apparatus or an object recognition method according to an example of the present disclosure; and

FIG. 16 shows an example of a computing system related to an object recognition apparatus and an object recognition method according to an example of the present disclosure.

### DETAILED DESCRIPTION

Hereinafter, some examples of the present disclosure will be described in detail with reference to the example drawings. In adding the reference numerals to the components of each drawing, it should be noted that the identical or equivalent component is designated by the identical numeral even if they are displayed on other drawings. Further, in describing the example of the present disclosure, a detailed description of well-known features or functions will be ruled out in order not to unnecessarily obscure the gist of the present disclosure.

In describing the components of the example according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

Further, the terms “unit”, “device”, “member”, “body”, or the like used hereinafter may indicate at least one shape structure or may indicate a unit for processing a function.

In addition, in examples of the present disclosure, the expressions “greater than” or “less than” may be used to indicate whether a specific condition is satisfied or fulfilled, but are used only to indicate examples, and do not exclude “greater than or equal to” or “less than or equal to”. A condition indicating “greater than or equal to” may be replaced with “greater than”, a condition indicating “less than or equal to” may be replaced with “less than”, a condition indicating “greater than or equal to and less than” may be replaced with “greater than and less than or equal to”. In addition, ‘A’ to ‘B’ means at least one of elements from ‘A’ (including ‘A’) to ‘B’ (including ‘B’).

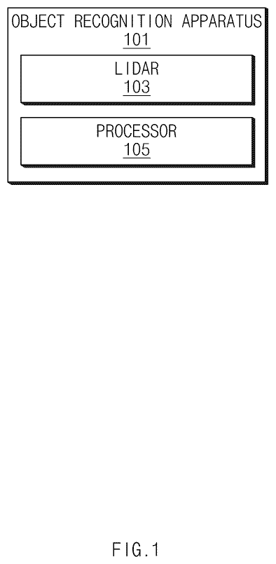

Hereinafter, examples of the present disclosure will be described in detail with reference to FIGS. 1 to 16.

FIG. 1 is a block diagram showing an object recognition apparatus according to an example of the present disclosure.

Referring to FIG. 1, an object recognition apparatus 101 according to an example of the present disclosure may be implemented inside a vehicle. In this case, the object recognition apparatus 101 may be integrally formed with internal control units of the vehicle, or may be implemented as a separate device and connected to the control units of the vehicle by separate connection means.

Referring to FIG. 1, the object recognition apparatus 101 may include a sensor (e.g., LIDAR 103, Radar, Sonar, Infrared Cameras, Magnetic Sensors, etc.) and a processor 105.

According to an example, the processor 105 of the object recognition apparatus 101 may obtain position information about points of an object around the host vehicle including the object recognition apparatus 101 through the LIDAR 103.

According to an example, the processor 105 of the object recognition apparatus 101 may identify position information of a point corresponding to the object based on LIDAR points representing the object.

According to an example, the processor 105 of the object recognition apparatus 101 may identify whether the object is located within a lane based on the road boundary and the position of the object. The processor 105 of the object recognition apparatus 101 may assign, to the object, a reliability value indicating that the object is a moving object (e.g., a moving vehicle) or a stationary object that is able to be in a moving state (e.g., a stationary vehicle), with respect to the object located in the lane.

According to an example, a reliability value assigned to an object that is located in a merging section and has a width less than a specified width and a length less than a specified length may be larger than a reliability value assigned to an object that is not located in a merging section or has a width greater than the specified width or a length greater than the specified length.

In a conventional object recognition apparatus, if two or more different lanes merge, the processor of the conventional object recognition apparatus of the host vehicle located in one of the merging lanes may identify an object located in the other lane that is the subject of merge as being out of the lane. This is because the object may be located in a lane outside the boundary of the road where the host vehicle is located.

In the object recognition apparatus 101 according to an example, if two or more different lanes merge, the processor 105 of the object recognition apparatus 101 of the host vehicle located in one of the merging lanes may identify an object located in the other lane (e.g., the host lane) that is the subject of merge as being located in a merging section. The object located in the merging section may be assigned a reliability value indicating that the object is a moving object or a stationary object that is able to be in a moving state.

A driver may identify the merging of lanes based on road surface markings (e.g., inverted triangle markings on the road surface, hatched markings in the safety zone, double white lines markings), but the processor 105 of the object recognition apparatus 101 according to an example may be difficult to obtain road surface information through the LIDAR 103. Therefore, the processor 105 of the object recognition apparatus 101 according to an example may identify the merging of lanes according to road boundary information and information on road structures (e.g., guardrails, gaze guides). The processor 105 of the object recognition apparatus 101 may identify an object smaller than a specified size as a road structure.

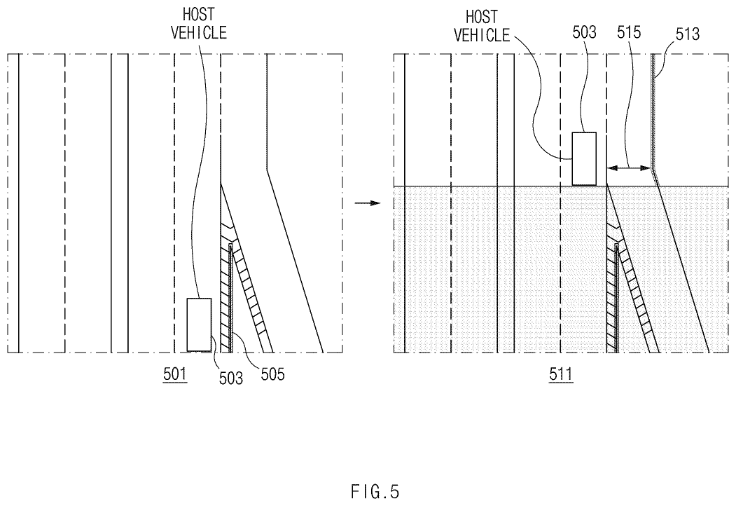

According to one example, the processor 105 of the object recognition apparatus 101 may identify a merging of lanes, based on at least one of a difference between the lateral position of a point on the road boundary corresponding to the longitudinal position of the host vehicle obtained through the LIDAR 103 in a specific frame and the lateral position of the point on the road boundary in a frame after the specific frame, the lateral position of at least one road structure having a size smaller than the specified size obtained through the LIDAR, or the longitudinal position of the at least one road structure, or any combination thereof. A method for identifying a merging of lanes will be described below with reference to FIGS. 5 to 7.

According to an example, the processor 105 of the object recognition apparatus 101 may calculate a score value representing a probability that an object is a moving object or a stationary object that is able to be in a moving state based on a reliability value according to the in-lane information of the object. The identifying of a score value indicating the probability that the object is in a moving state or an object that is able to be in a moving state based on the reliability value according to the in-lane information.

According to an example, the processor 105 of the object recognition apparatus 101 may identify an object as a moving object or an object that is able to be in a moving state based on the score value indicating the probability that the object is in a moving state or an object that is able to be in a moving state being greater than the score value indicating the probability that the object is an object that is unable to be in a moving state.

According to an example, the processor 105 of the object recognition apparatus 101 may assign, to the object, an identifier for indicating that the object is a moving object or a stationary object that is able to be in a moving state based on identifying that the object is a moving object or a stationary object that is able to be in a moving state. The processor 105 of the object recognition apparatus 101 may assign, to the object, an identifier indicating that the object is an object that is unable to be in a moving state, based on identifying that the object is an object that is unable to be in a moving state. The identifier may be referred to as a flag, but may not be limited thereto.

According to an example, the processor 105 of the object recognition apparatus 101 may control the operation of the host vehicle based on whether the object is a moving object, whether the object is a stationary object that is able to be in a moving state, or whether the object is an object that is unable to be in a moving state.

In a conventional object recognition apparatus, if the overall shape of an object is not identified in the portion of a lane where lanes merge, the shape of the object may be misrecognized. Therefore, the performance of object identification in the portion of the lane where lanes merge may be lower compared to performance of object identification in the portion of a lane where lanes do not merge. This is because the accumulation of incorrect shape identification, resulting in a delay in determining whether the object is a moving object or a stationary object that is able to be in a moving state. If an object cutting into the lane where the host vehicle is located is misrecognized, the speed of the host vehicle may not slow down. This may cause sudden braking issues.

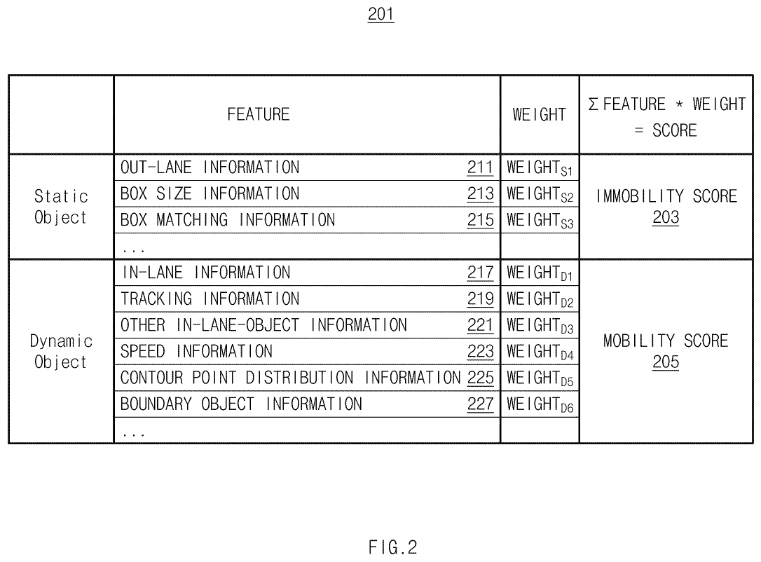

FIG. 2 is a table showing information used to classify objects in an object recognition apparatus or an object recognition method according to an example of the present disclosure.

Referring to FIG. 2, a table 201 may show types of pieces of information for calculating a score for identifying whether an object is a moving object (e.g., cars, bicycles, pedestrians, wheelchairs, scooters, etc.) or a stationary object (e.g., parked cars, parked motorcycles, shopping carts, etc.) that is able to in a moving state. An immobility score 203 may represent a score for identifying whether an object is an object (e.g., road signs, traffic lights, utility poles, fire hydrants, mailboxes, benches, guardrails, curbs, parking meters, bus stops, etc.) incapable of being in a moving state. The immobility score 203 may be identified based on information such as out-lane information 211, box size information 213, and box matching information 215. A mobility score 205 may represent a score for identifying whether an object is a moving object or a stationary object that is able to in a moving state. The mobility score 205 may be identified based on information such as in-lane information 217, tracking information 219, other in-lane object information 221, speed information 223, LIDAR point distribution information 225, and boundary object information 227.

According to an example, a first reliability may be reliability for determining whether an object is an object incapable of being in a moving state. The processor of the object recognition apparatus may identify the immobility score 203 by the sum of values obtained by multiplying first reliabilities indicated by pieces of information by a weight. A second reliability may be a reliability for determining whether the object is a moving object or a stationary object that is able to be in a moving state. The processor of the object recognition apparatus may identify the mobility score 205 by the sum of values obtained by multiplying second reliabilities indicated by pieces of information by a weight.

According to an example, the out-lane information 211 for identifying the immobility score 203 may represent a first reliability assigned based on whether an object is identified outside a lane. The box size information 213 for identifying the immobility score 203 may represent a first reliability assigned based on whether the size of an object box is greater than or equal to a reference size. The box matching information 215 for identifying the immobility score 203 may indicate a first reliability assigned based on the degree of matching between the distribution of LIDAR points and the object box.

According to an example, the in-lane information 217 may represent a second reliability assigned based on whether an object is identified inside a lane. The tracking information 219 may represent a second reliability assigned based on whether an object is moving. The speed information 223 may represent a second reliability assigned based on the speed of an object. The boundary object information 227 may represent a second reliability assigned based on whether an object is viewed without being obscured at the boundary of a field of view.

According to an example, the immobility score 203 may be identified by the sum of values obtained by multiplying the first reliabilities represented by pieces of information by a weight. For example, the immobility score 203 may be identified by the sum of a value obtained by multiplying the first reliability according to the out-lane information 211 by a weight (e.g., weightₛ₁) corresponding to the out-lane information 211, a value obtained by multiplying the first reliability according to the box size information 213 by a weight (e.g., weightₛ₂) corresponding to the box size information 213, a value obtained by multiplying the first reliability according to the box matching information 215 by a weight (e.g., weightₛ₃) corresponding to the box matching information 215, or at least one of any combination thereof. However, examples of the present disclosure may not be limited thereto. According to an example, the immobility score 203 may be identified by adding up not only a value obtained by multiplying information listed in the table 201 by a weight, but also a value obtained by multiplying information not listed in the table 201 by the weight.

According to an example, the mobility score 205 may be identified by the sum of values obtained by multiplying the second reliabilities represented by pieces of information by a weight. For example, the mobility score 205 may be identified based on a value obtained by the sum of at least one of a value obtained by multiplying the second reliability according to the in-lane information 217 by a weight (e.g., weight_{D1}) corresponding to the in-lane information 217, a value obtained by multiplying the second reliability according to the tracking information 219 by a weight (e.g., weight_{D2}) corresponding to the tracking information 219, a value obtained by multiplying the second reliability according to the other in-lane object information 221 by a weight (e.g., weight_{D3}) corresponding to the other in-lane object information 221, a value obtained by multiplying the second reliability according to the speed information 223 by a weight (e.g., weight_{D4}) corresponding to the speed information 223, a value obtained by multiplying the second reliability according to the LIDAR point distribution information 225 by a weight (e.g., weight_{D5}) corresponding to the LIDAR point distribution information 225, or a value obtained by multiplying the second reliability according to the boundary object information 227 by a weight (e.g., weight_{D6}) corresponding to the boundary object information 227, or any combination thereof. However, examples of the present disclosure may not be limited thereto. According to an example, the mobility score 205 may be identified by adding up not only a value obtained by multiplying information listed in the table 201 by a weight, but also a value obtained by multiplying information not listed in the table 201 by the weight.

According to an example, if the mobility score 205 for a specific object is higher than the immobility score 203 for the specific object, the processor of the object recognition apparatus may identify the specific object as a moving object or a stationary object that is able to be in a moving state. According to an example, if the immobility score 203 for a specific object is higher than the mobility score 205 for the specific object, the processor of the object recognition apparatus may identify that the specific object is an object that is unable to be in a moving state.

According to an example of the present disclosure, the processor of the object recognition apparatus may identify the second reliability indicated by the in-lane information 217. Hereinafter, the value of the second reliability indicated by the in-lane information 217 may be referred to as a reliability value.

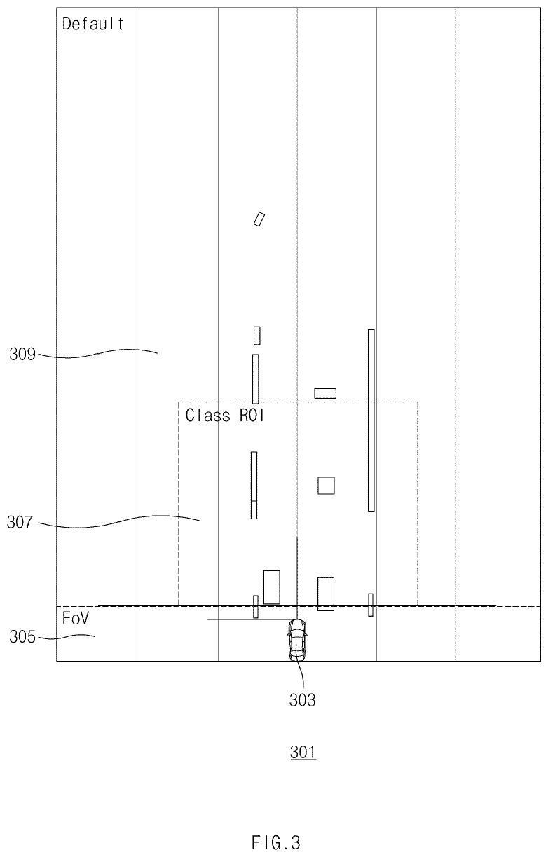

FIG. 3 illustrates a region in which the weights of reliability values are changed according to information related to an object recognition apparatus or an object recognition method according to an example of the present disclosure.

Referring to FIG. 3, a frame 301 may represent a first region 305, a second region 307, and a third region 309, which are separated according to distances from a host vehicle 303 including the object recognition apparatus. The first region 305 may include a region within a field of view. The second region 307 may include a region for classifying objects of interest. The third region 309 may include a region other than the first region 305 and the second region 307.

According to an example, the first region 305 may be referred to as a field of view (FoV) region, but may not be limited thereto. The FoV is the extent of the observable world that is seen at any given moment by a sensor, camera, or human eye. It may be measured as an angle, in degrees, and represent the area that the sensor or camera may capture or detect at once. The FoV may be described in both horizontal and vertical dimensions. The second region 307 may be referred to as a class region of interest (class ROI), but may not be limited thereto. The class ROI may be a specific area within an image or a scene that is relevant for a particular classification task. The class ROI may be used to focus on parts of an image that are significant for identifying or classifying objects, features, or patterns. The third region 309 may be referred to as a default region, but may not be limited thereto.

According to an example, the processor of the object recognition apparatus may assign different weights (e.g., weights in FIG. 2) for identifying an immobility score or a mobility score according to a region in which an object is included. This is because information of high importance may vary depending on the position of an object. For example, the processor of the object recognition apparatus may set the weight of the LIDAR point distribution information (e.g., the LIDAR point distribution information 225 of FIG. 2) to a value greater than zero only in the second region 307. For example, the processor of the object recognition apparatus may set a weight of boundary object information (e.g., the boundary object information 227 in FIG. 2) in the first region 305 greater than a weight of the boundary object information in the second region 307 and a weight of the boundary object information in the third region 309.

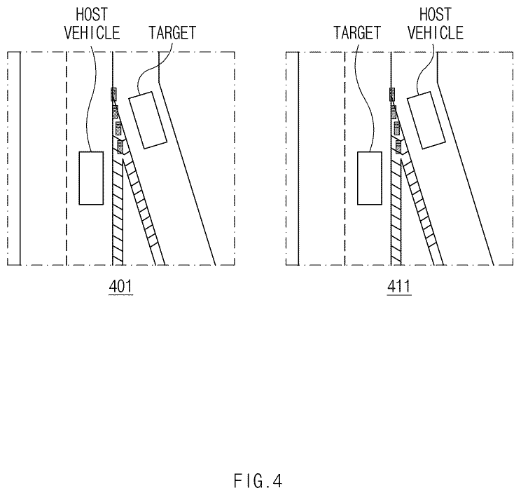

FIG. 4 shows an example of a lane in which a host vehicle is located in an object recognition apparatus or an object recognition method according to an example of the present disclosure.

Referring to FIG. 4, in a first situation 401, a host vehicle may be located in a lane that is the subject of a merge (e.g., a target lane) and an object may be located in a lane that is merged (e.g., a merge lane). In a second situation 411, the host vehicle may be located in the merge lane and the object may be located in the lane that is the subject of the merge (e.g., intersections, pedestrian crossings, highway merges and exits, lane reductions, curves and turns, railroad crossings, Roundabouts, etc.).

According to an example, the processor of the object recognition apparatus may identify the merging of lanes in the first situation 401 and the second situation 411, identify a merging section, and determine whether the object is a moving object, whether the object is a stationary object that is able to be in a moving state, or whether the object is an object that is unable to be in a moving state.

In an example, the processor of the object recognition apparatus may identify whether lanes are merging, and the position of the merging section based on a change in position of a road boundary or a change in position of a road structure.

The processor of the object recognition apparatus may improve recognition performance by applying, to objects located in the merging section, different weights for identifying whether the object is a moving object, or whether the object is a stationary object that is able to be in a moving state.

FIG. 5 shows an example of a merging of lanes that are identified based on a change in the lateral position of a point on a road boundary (e.g., curbs, shoulders, guardrails, fences, painted lines, median barriers, hedges or landscaping, ditches, bollards, parking barriers, railings, cliffs, etc.), in an object recognition apparatus or an object recognition method according to an example of the present disclosure.

Referring to FIG. 5, a first situation 501 may represent a first road boundary 505, and surrounding conditions as identified by an object recognition apparatus of a vehicle 503 in a specific frame. A second situation 511 may represent a second road boundary 513 identified by the object recognition apparatus of the vehicle 503 and surrounding conditions in a frame after the specific frame. A difference value 515 may represent a difference between the lateral position of the point on the road boundary in the specific frame and the lateral position of the point on the road boundary in a frame after the specific frame.

According to an example, the processor of the object recognition apparatus may identify the merging of lanes based on a difference (e.g., the difference value 515) between a lateral position of the point on the road boundary in the specific frame (e.g., a lateral position of the point corresponding to the host vehicle 503 on the first road boundary 505) and a lateral position of the point on the road boundary in a frame after the specific frame (e.g., a lateral position of the point corresponding to the host vehicle 503 on the second road boundary 513) falling within a specified range and the road boundary (e.g., the first road boundary 505) including the point on the road boundary in the specific frame being one of the both lines of the lane in which the host vehicle 503 is located. The specified range may include a range that is greater than a value based on the width of a single lane and less than a value based on the width of a plurality of lanes (e.g., about three lanes).

The reason for this is that, if the difference (e.g., the difference value 515) between the lateral position of a point on the road boundary in the specific frame and the lateral position of the point on the road boundary in a frame after the specific frame is greater than the width of the plurality of lanes, the road boundary in a frame after the specific frame may not be the second road boundary 513 located in the same direction as the direction in which the first road boundary 505 is located in the specific frame, with respect to the host vehicle 503.

According to an example, the processor of the object recognition apparatus may identify the merging section to reduce the risk of an accident caused by incorrectly recognizing an object located in the merging section as an object that is unable to be in a moving state. If the vehicle 503 is not located in a lane immediately adjacent to the point where the lanes merge, the processor of the object recognition apparatus may not determine whether the lanes merge because the risk of an accident is lower than a threshold, even if the vehicle 503 incorrectly recognizes an object as an object that is unable to be in a moving state.

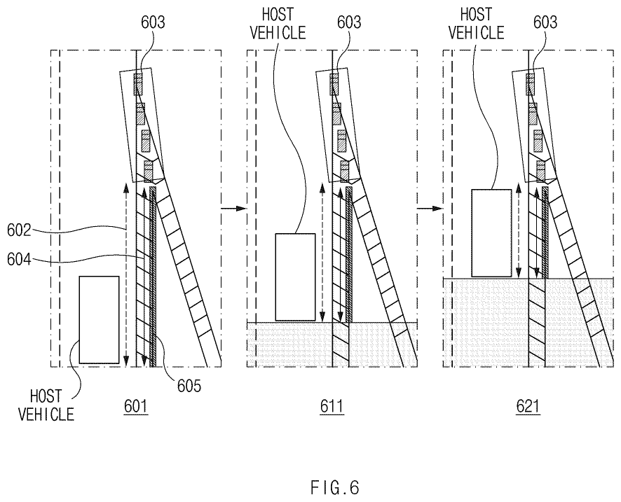

FIG. 6 shows an example of merging of lanes identified based on a point on a road boundary, and a road structure located at the point on the road boundary, in an object recognition apparatus or an object recognition method according to an example of the present disclosure;

Referring to FIG. 6, a first situation 601, a second situation 611, and a third situation 621 may represent a change in position of the at least one road structure 603 and a road boundary 605, as a host vehicle is traveling.

According to an example, if a point on the road boundary 605 (e.g., a point corresponding to the host vehicle on the road boundary 605) located in the same direction as the direction in which the at least one road structure 603 is located with respect to the at least one road structure 603 and the host vehicle is located is identified, the processor of the object recognition apparatus may identify that the difference between the lateral position of the point on the road boundary 605 in the specific frame and the lateral position of at least one of the at least one road structure 603 is less than a preset value. In other words, the processor of the object recognition apparatus may identify that a road structure is located on the road boundary.

According to an example, the processor of the object recognition apparatus may identify that the maximum longitudinal position value of the longitudinal position values of the points on the road boundary 605 decreases over time. In the first situation 601, the second situation 611, and the third situation 621, the processor of the object recognition apparatus may identify that the maximum longitudinal position value of the longitudinal position values of the points on the road boundary 605 approaches the host vehicle over time. The maximum longitudinal position value may be determined based on a first difference value 604.

According to an example, at least one of the at least one road structure 603 may be located in the same direction as the direction in which the point on the road boundary 605 is located in a specific frame, with respect to the host vehicle.

According to an example, the processor of the object recognition apparatus may identify that the minimum longitudinal position value of the longitudinal position values of the at least one road structure 603 decreases over time. In the first situation 601, the second situation 611, and the third situation 621, the processor of the object recognition apparatus may identify that the minimum longitudinal position value of the longitudinal position values of the at least one road structure 603 approaches the host vehicle over time. The minimum longitudinal position value may be determined based on a second difference value 602.

According to an example, the processor of the object recognition apparatus may identify a merging of lanes based on a difference between a lateral position of a point on the road boundary 605 and a lateral position of the at least one road structure 603 in a specific frame being less than a preset value, a maximum longitudinal position value of the longitudinal position values of the road boundary 605 at which the points on the road boundary 605 are located decreasing over time, or a minimum longitudinal position value of the longitudinal position values of the at least one road structure 603 decreasing over time.

According to an example, the processor of the object recognition apparatus may identify whether the longitudinal position value of a point on the road boundary 605, and the minimum longitudinal position value of the at least one road structure 603 approach the host vehicle as the vehicle is traveling, during the five stacks stored in the memory.

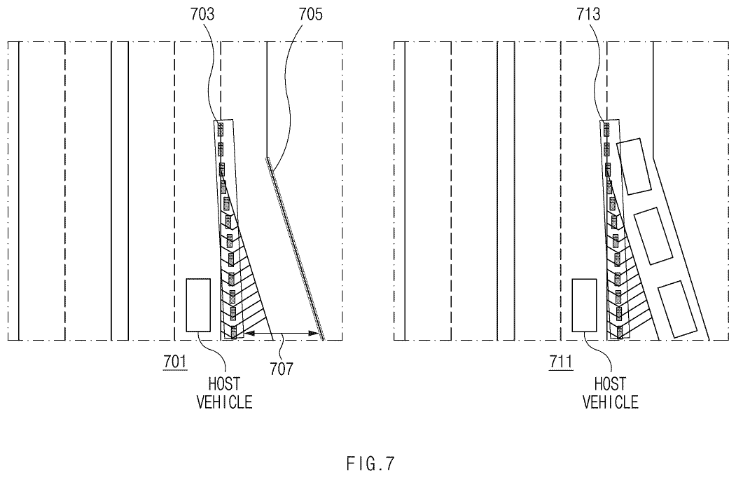

FIG. 7 shows an example of merging of lanes identified based on a point on a road boundary, and a road structure spaced apart from a point on a road boundary, in an object recognition apparatus or an object recognition method according to one example of the present disclosure.

Referring to FIG. 7, in a first situation 701, the processor of the object recognition apparatus may identify at least one road structure 703 and identify a point on a road boundary 705 located in the same direction as the direction in which the at least one road structure 703 is located with respect to the host vehicle.

In a second situation 711, the processor of the object recognition apparatus may identify at least one road structure 713 and may not identify a point on the road boundary located in the same direction as the direction in which the at least one road structure 713 is located, with respect to the host vehicle. For example, the road boundary located in the same direction as the direction in which the at least one road structure 713 is located with respect to the host vehicle may be obscured by an object, or another object that is different from the object.

According to an example, in the first situation 701, the processor of the object recognition apparatus may identify the merging of lanes based on a difference between a lateral position of the road structure 713 corresponding to the the longitudinal position of the host vehicle among lateral positions of the at least one road structure 703, and a lateral position of a point on the road boundary 705 located in the same direction as the direction in which the at least one road structure 703 is located with respect to the host vehicle, being greater than a preset difference value based on a lane width. To exclude cases where the at least one road structure 703 is installed immediately adjacent to the road boundary, the preset difference value may include a value based on the width of one lane.

According to an example, in the second situation 711, the processor of the object recognition apparatus may identify the merging of lanes based on a decrease over time in the minimum longitudinal position value of the longitudinal position value of the at least one road structure 713.

According to an example, the processor of the object recognition apparatus may identify whether the minimum longitudinal position value of the road structure approaches the host vehicle as the host vehicle is traveling, during five stacks stored in the memory.

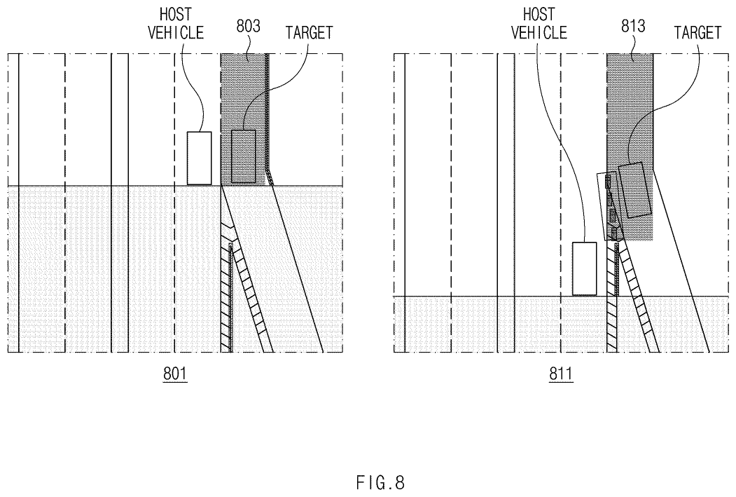

FIG. 8 shows an example of a merging section being identified according to a manner of identifying a merging in an object recognition apparatus or an object recognition method, according to one example of the present disclosure.

Referring to FIG. 8, a first situation 801 may illustrate a first merging section 803, which is a merging section where the processor of the object recognition apparatus identifies a merging of lanes based on at least one of the following: a difference between the lateral position of a point on a road boundary in a specific frame and the lateral position of the point on the road boundary in a frame after the specific frame falling within a specified range; or a road boundary including the point on the road boundary in the specific frame being one of both lines of the lane in which the host vehicle is located; or any combination thereof.

A second situation 811 may illustrate a second merging section 813, which is a merging section where the processor of the object recognition apparatus identifies merging of lanes based on at least one of the following: a difference between a lateral position of a point on the road boundary and a lateral position of the at least one road structure in a specific frame being less than a preset value; a maximum longitudinal position value of the longitudinal position values of the road boundary 605 at which the points on the road boundary are located decreasing over time; or a minimum longitudinal position value of the longitudinal position values of the at least one road structure decreasing over time.

If two or more lanes merge, the risk of an accident on regions of the lane after a merging point may be higher than a threshold. Therefore, according to an example, the processor of the object recognition apparatus may identify a region on the lane after the merging point as a merging section (e.g., highway on-ramps, lane reductions, end of passing lane, exist ramps with multiple entry points, construction zones, intersection merges, roundabout exits, toll plaza exits, service roads, etc.) based on a specified time interval, or a specified distance, even after the merging of lanes.

According to an example, in the first situation 801, the processor of the object recognition apparatus may obtain a third time point at which the merging is identified and a fourth time point at which the host vehicle has traveled a specified distance (e.g., about 10 meters). During the time period from the third time point to the fourth time point, the processor of the object recognition apparatus may identify a region between a line including a point on the road boundary in a specific frame and a road boundary including the point on the road boundary in a frame after the specific frame as a merging section (e.g., first merging section 803, highway on-ramps, lane reductions, end of passing lane, exist ramps with multiple entry points, construction zones, intersection merges, roundabout exits, toll plaza exits, service roads, etc.).

For example, whether a vehicle has traveled a specified distance may be identified based on the speed of the host vehicle. For example, if the speed of the vehicle is 50 kph (kilometer per hour), the host vehicle may travel the specified distance in about 0.72 seconds. If the LIDAR identifies surrounding environment about every 80 milli-seconds (ms), the fourth time point may include about nine times the LIDAR identifies surrounding environment after the merging of lanes.

According to an example, in the second situation 811, the processor of the object recognition apparatus may identify merging of lanes based on at least one of the following: a difference between a lateral position of a point on the road boundary and a lateral position of at least one of the at least one road structure in a specific frame being less than a preset value; a maximum longitudinal position value of the longitudinal position values of the road boundary at which the points on the road boundary are located decreasing over time; or a minimum longitudinal position value of the longitudinal position values of the at least one road structure decreasing over time; or any combination thereof.

According to an example, in the second situation 811, the processor of the object recognition apparatus may obtain a first time point at which the merging is identified, and a second time point at which a specified time period has been elapsed after the time point at which at least one road structure with a size smaller than a specified size is not identified. During the time period from the first time point to the second time point, the processor of the object recognition apparatus may identify a region between a line corresponding to a lateral position of the at least one road structure and a lateral position spaced apart from the line by the width of the lane as a merging section (e.g., the second merging section 813, highway on-ramps, lane reductions, end of passing lane, exist ramps with multiple entry points, construction zones, intersection merges, roundabout exits, toll plaza exits, service roads, etc.).

For example, the specified time period may include a time period during which the LIDAR identifies the surrounding environment a specified number of times (e.g., approximately five times).

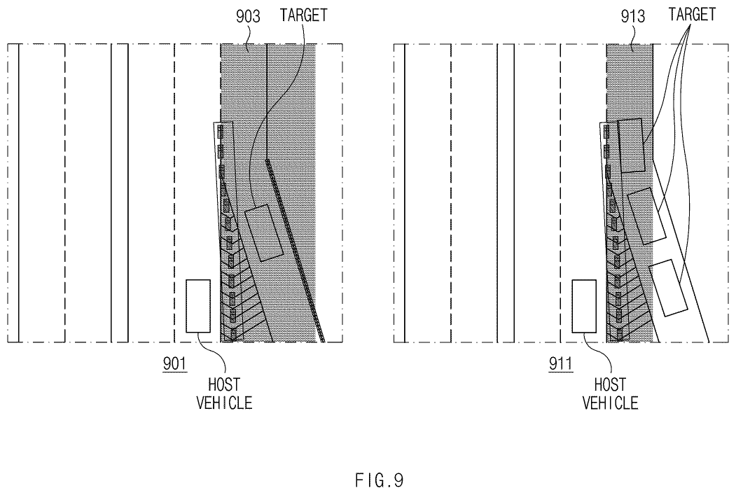

FIG. 9 shows another example of a merging section (e.g., highway on-ramps, lane reductions, end of passing lane, exist ramps with multiple entry points, construction zones, intersection merges, roundabout exits, toll plaza exits, service roads, etc.) being identified according to a manner of identifying merging in an object recognition apparatus or an object recognition method, according to one example of the present disclosure.

Referring to FIG. 9, a first situation 901 may illustrate a first merging section 903 that is a merging section in a case where the processor of the object recognition apparatus may identify the merging of lanes based on a difference between a lateral position of the road structure corresponding to the the longitudinal position of the host vehicle among lateral positions of the at least one road structure, and a lateral position of a point on the road boundary located in the same direction as the direction in which the at least one road structure is located with respect to the host vehicle, being greater than a preset difference value based on a lane width.

A second situation 911 may illustrate a second merging section 913, which is a merging section in a case where the processor of the object recognition apparatus has identified a merging of lanes based on a minimum longitudinal position value among the longitudinal position values of at least one road structure (e.g., bridges, tunnels, overpasses, underpasses, flyovers, interchanges, roundabouts, causeways, culverts, viaducts, sound barriers, medial barriers, tool booths, speed bumps, traffic islands, etc.) decreasing over time.

If two or more lanes merge, as in the second situation 811 of FIG. 8, the risk of an accident may be higher than a threshold value in a region of the lane after the point of merging. Therefore, according to an example, the processor of the object recognition apparatus may identify a region on the lane after the merging point as a merging section based on a specified time period, even after the merging of lanes.

According to an example, in the first situation 901, the processor of the object recognition apparatus may obtain a first time point at which the merging is identified and a second time point at which a specified time period has elapsed from the time point at which at least one road structure is not identified. During the time period from the first time point to the second time point, the processor of the object recognition apparatus may identify a region between a line corresponding to a lateral position of the at least one road structure and the point on the road boundary as a merging section (e.g., the first merging section 903). For example, the specified time period may include a time period during which the LIDAR identifies the surrounding environment a specified number of times (e.g., about five times).

According to an example, in the second situation 911, the processor of the object recognition apparatus may obtain a first time point at which the merging is identified and a second time point at which the specified time period has elapsed from the time point at which at least one road structure is not identified. During the time period from the first time point to the second time point, the processor of the object recognition apparatus may identify a region between a line corresponding to a lateral position of the at least one road structure and the lateral position spaced apart from the line by the width of a lane as a merging section (e.g., the second merging section 913).

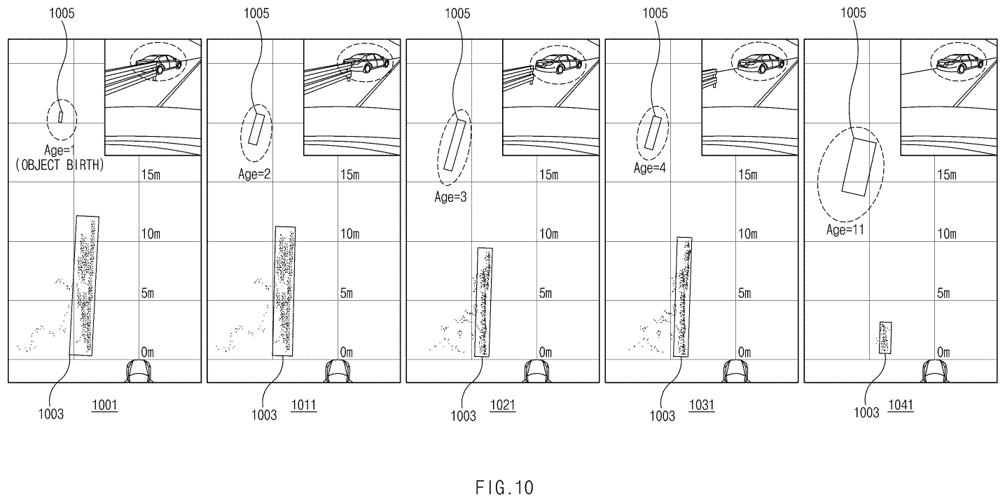

FIG. 10 shows an example of object identification by which an object is classified in an object recognition apparatus or an object recognition method according to an example of the present disclosure.

Referring to FIG. 10, a first situation 1001, a second situation 1011, a third situation 1021, a fourth situation 1031, and a fifth situation 1041 may represent a road structure 1003 along a host vehicle located on a road that is the subject to merging is traveling, and an object 1005 located on a merge lane.

In the first situation 1001, the second situation 1011, and the third situation 1021, the processor of the object recognition apparatus according to an example may identify the object 1005 that is obscured by the road structure 1003 (e.g., a guardrail). Because the object 1005 is obscured by the road structure 1003, the object 1005 may represent partial shape information of the object. Because the object 1005 is first identified in the first frame of the first situation 1001, the age information of the object 1005 may be indicated by 1. In the second situation 1011, the age information of the object 1005 may be indicated by 2. In the third situation 1021, the age information of the object 1005 may be indicated by 3.

In the fourth situation 1031, the processor of the object recognition apparatus according to an example may identify a merging section (e.g., highway on-ramps, lane reductions, end of passing lane, exist ramps with multiple entry points, construction zones, intersection merges, roundabout exits, toll plaza exits, service roads, etc.). According to an example, based on the object being identified at the merging section, the processor of the object recognition apparatus may store information in frames after the frame in which the object is identified in the merging section in association with the object as history information. In other words, the processor of the object recognition apparatus may not store information about the object in a previous frame in which the object is identified in the merging section (e.g., inaccurate shape information in the previous frame) in association with the object. In the fourth situation 1031, the age information of the object 1005 may be indicated by 4.

In the fifth situation 1041, the processor of the conventional object recognition apparatus may identify the object 1005 as a moving object if the age information of the object 1005 is 11. The reason for this is that a conventional object recognition apparatus may have inaccurate history information about the object's shape because the object 1005 in the merging section may be obscured by the road structure 1003.

In the fifth situation 1041, the processor of the object recognition apparatus according to an example may identify the object 1005 as a moving object if the age information of the object 1005 is 7. In other words, the performance of the object classification of the object recognition apparatus according to an example may be improved compared to the performance of the object classification of a conventional object recognition apparatus.

In the fifth situation 1041, the processor of the conventional object recognition apparatus may determine that an object identified outside of the road structure 1003 is an object that is unable to be in a moving state. The processor of the object recognition apparatus according to an example may not determine that an object identified outside of the road structure 1003 is an object that is unable to be in a moving state if the object is included within the merging section.

According to an example, the processor of the object recognition apparatus may identify the object 1005 as not being obscured by the road structure 1003 if the object 1005 located in the merging section is obscured by the road structure 1003.

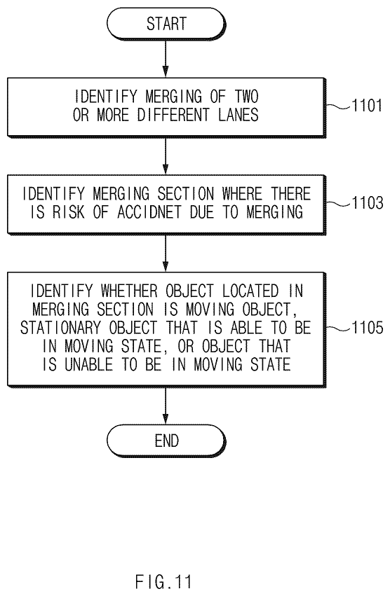

FIG. 11 shows an example of a flowchart of operations of an object recognition apparatus for classification and identification of an object, in an object recognition apparatus or an object recognition method, according to an example of the present disclosure.

Hereinafter, it is assumed that the object recognition apparatus 101 of FIG. 1 performs the process of FIG. 11. Additionally, in the description of FIG. 11, operations described as being performed by the apparatus may be understood as being controlled by the processor 105 of the object recognition apparatus 101.

Referring to FIG. 11, in a first operation 1101, the processor of an object recognition apparatus according to an example may identify a merging of two or more different lanes.

According to an example, the processor of the object recognition apparatus may identify, via LIDAR, the merging of two or more different lanes based on at least one of a lateral position of a point on a road boundary or a lateral position of at least one road structure, or any combination thereof.

In a second operation 1103, the processor of the object recognition apparatus according to an example may identify a merging section where there is a risk of an accident caused by the merging.

According to an example, the processor of the object recognition apparatus may identify the merging section where there is a risk of an accident due to merging, based on at least one of: whether the merging is identified, a specified time period, or a specified distance, or any combination thereof.

In the third operation 1105, the processor of the object recognition apparatus according to an example may identify whether an object located in the merging section is a moving object, a stationary object that is able to be in a moving state, or an object that is unable to be in a moving state.

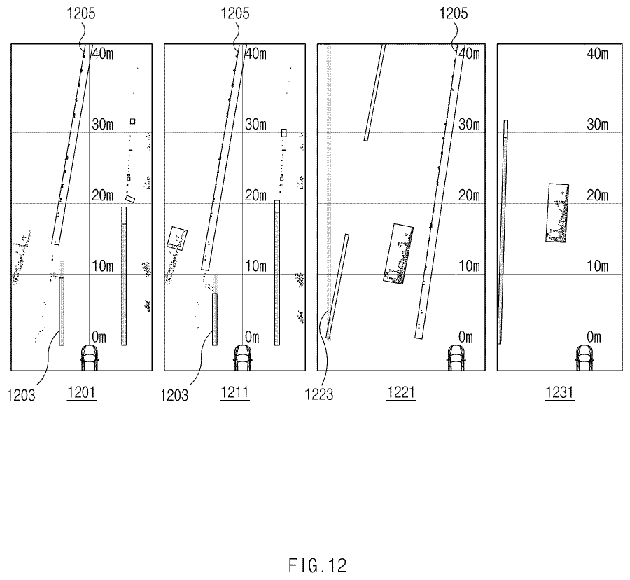

FIG. 12 shows an example of object identification by a host vehicle located on a merging lane in an object recognition apparatus or an object recognition method according to an example of the present disclosure.

Referring to FIG. 12, in a first situation 1201, a second situation 1211, a third situation 1221, and a fourth situation 1231, the processor of an object recognition apparatus may show a first road boundary 1203, a second road boundary 1223, and at least one road structure 1205 that are identified as a host vehicle is traveling.

In the first situation 1201 and the second situation 1211, the processor of the object recognition apparatus included in the host vehicle located on a merging lane may identify the at least one road structure 1205 and the first road boundary 1203.

In the second situation 1211, the processor of the object recognition apparatus may identify a merging of lanes based on a difference between a lateral position of a point on the first road boundary 1203 and a lateral position of the at least one road structure 1205 in a specific frame being less than a preset value, a maximum longitudinal position value of the longitudinal position values of the first road boundary 1203 decreasing over time, or a minimum longitudinal position value of the longitudinal position values of the at least one road structure 1205 decreasing over time. Accordingly, the processor of the object recognition apparatus may identify a merging section.

In the third situation 1221, the processor of the object recognition apparatus may identify a region between a line corresponding to the lateral position of at least one road structure and a lateral position spaced apart from the line by the width of the lane as a merging section.

The processor of the object recognition apparatus may identify the merging of lanes based on a difference between a lateral position of the road structure corresponding to the the longitudinal position of the host vehicle among lateral positions of the at least one road structure, and a lateral position of a point on the road boundary located in the same direction as the direction in which the at least one road structure is located with respect to the host vehicle, being greater than a preset difference value based on a lane width.

In the fourth situation 1231, the processor of the object recognition apparatus may obtain a first time point at which the merging is identified, and a second time point at which a specified time period has been elapsed after the time point at which at least one road structure with a size smaller than a specified size is not identified. During the time period from the first time point to the second time point, the processor of the object recognition apparatus may identify a region between a line corresponding to a lateral position of the at least one road structure and a lateral position spaced apart from the line by the width of the lane as a merging section.

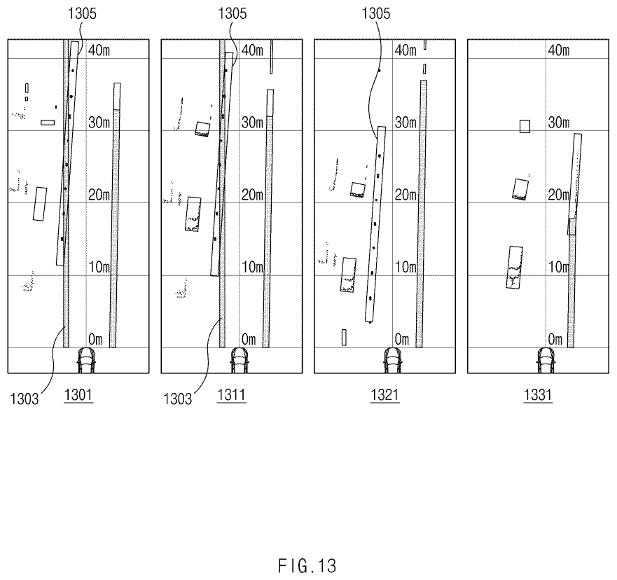

FIG. 13 shows another example of object identification by a host vehicle located on a merging lane in an object recognition apparatus or an object recognition method, according to an example of the present disclosure.

Referring to FIG. 13, in a first situation 1301, a second situation 1311, a third situation 1321, and a fourth situation 1331, the processor of an object recognition apparatus may show a road boundary 1303 and at least one road structure 1305 that are identified as a host vehicle is traveling.

In the first situation 1301 and the second situation 1311, the processor of the object recognition apparatus included in the host vehicle located in a merging lane may identify the at least one road structure 1305 and the road boundary 1303.

In the second situation 1311, the processor of the object recognition apparatus may identify a merging of lanes based on a difference between a lateral position of a point on the road boundary 1303 and a lateral position of the at least one road structure 1305 in a specific frame being less than a preset value, a maximum longitudinal position value of the longitudinal position values of the road boundary 1303 decreasing over time, or a minimum longitudinal position value of the longitudinal position values of the at least one road structure 1305 decreasing over time. Accordingly, the processor of the object recognition apparatus may identify a merging section.

In the third situation 1321, the processor of the object recognition apparatus may identify that the road boundary 1303 has disappeared. Accordingly, the processor of the object recognition apparatus may obtain a first time point at which the merging is identified, and a second time point at which a specified time period has been elapsed after the time point at which at least one road structure 1305 with a size smaller than a specified size is not identified. During the time period from the first time point to the second time point, the processor of the object recognition apparatus may identify a region between a line corresponding to a lateral position of the at least one road structure and the lateral position spaced apart from the line by the width of the lane as a merging section.

In the fourth situation 1331, the processor of the object recognition apparatus may obtain a first time point at which the merging is identified, and a second time point at which a specified time period has been elapsed after the time point at which at least one road structure with a size smaller than a specified size is not identified. During the time period from the first time point to the second time point, the processor of the object recognition apparatus may identify a region between a line corresponding to a lateral position of the at least one road structure and the lateral position spaced apart from the line by the width of the lane as a merging section.

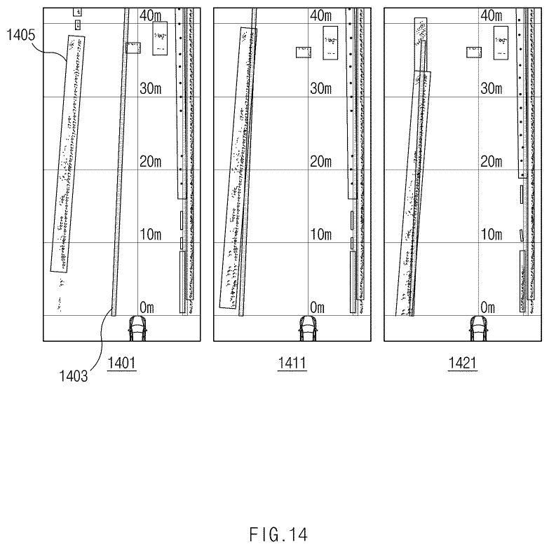

FIG. 14 shows an example of determination of a merging section by a host vehicle located on a lane that is the subject of merging in an object recognition apparatus or an object recognition method, according to one example of the present disclosure.

Referring to FIG. 14, in a first situation 1401, a second situation 1411, and a third situation 1421, the processor of an object recognition apparatus may show a first road boundary 1403 in a specific frame identified as a host vehicle is traveling, and a second road boundary 1405 in a frame after the specific frame.

In the first situation 1401, the processor of the object recognition apparatus included in the host vehicle located in a lane that is the subject of merging may identify the first road boundary 1403 in the specific frame and the second road boundary 1405 in a frame after the specific frame.

In the second situation 1411, the processor of the object recognition apparatus may identify the merge of lanes based on at least one of the following: a difference between a lateral position of the point on the road boundary in the specific frame (e.g., a lateral position of the point corresponding to the host vehicle on the first road boundary 1403) and a lateral position of the point on the road boundary in a frame after the specific frame (e.g., a lateral position of the point corresponding to the host vehicle on the second road boundary 1405) falling within a specified range; or the road boundary (e.g., the first road boundary 1403) including the point on the road boundary in the specific frame being one of the both lines of the lane in which the host vehicle is located, or any combination thereof.

According to an example, the processor of the object recognition apparatus may obtain a third time point at which the merging is identified and a fourth time point at which the host vehicle has traveled a specified distance (e.g., about 10 meters). During the time period from the third time point to the fourth time point, the processor of the object recognition apparatus may identify a region between a line including a point on the road boundary in a specific frame and the road boundary including the point on the road boundary in a frame after the specific frame as a merging section.

In the third situation 1421, the processor of the object recognition apparatus may identify that the first road boundary 1403 has disappeared. Therefore, the processor of the object recognition apparatus may obtain a third time point at which the merging is identified and a fourth time point at which the host vehicle has traveled a specified distance (e.g., about 10 meters). During the time period from the third time point to the fourth time point, the processor of the object recognition apparatus may identify a region between a line including a point on the road boundary in a specific frame and a road boundary including the point on the road boundary (e.g., the second road boundary 1405) in a frame after the specific frame as a merging section(.

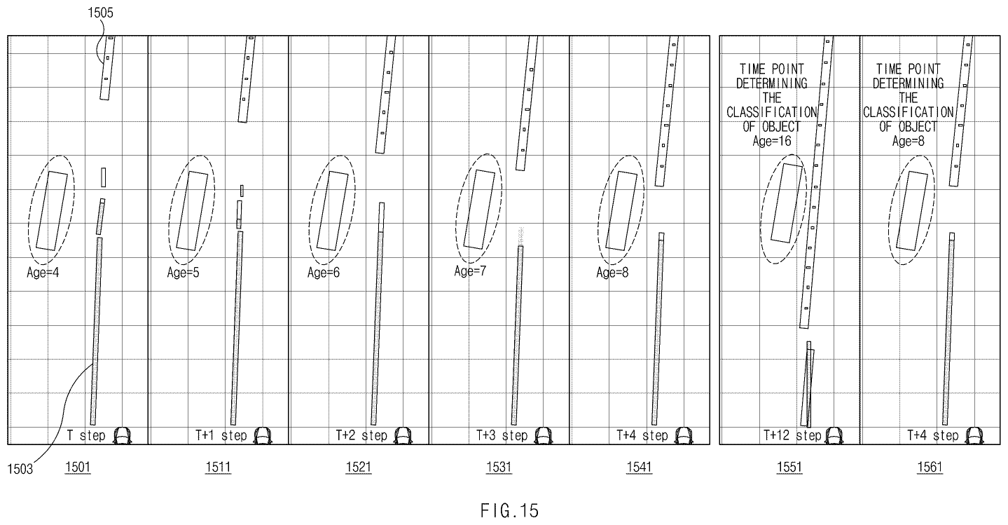

FIG. 15 shows an example of object identification in which an object is identified as a moving object in an object recognition apparatus or an object recognition method according to an example of the present disclosure.

Referring to FIG. 15, a first situation 1501, a second situation 1511, a third situation 1521, a fourth situation 1531, and a fifth situation 1541 may show a road structure along a host vehicle located on a road that is the subject to merging is traveling, and an object located on a merge lane.

In a sixth situation 1551, a conventional object recognition apparatus may identify an object with age information of 16 as a moving object, or a stationary object that is able to be in a moving state.

In a seventh situation 1561, the processor of the object recognition apparatus according to an example may identify an object with age information of 8 as a moving object.

In the first situation 1501, the second situation 1511, and the third situation 1521, the processor of an object recognition apparatus may identify a road structure 1505 and a road boundary 1503.

In the fifth situation 1541, the processor of the object recognition apparatus may identify a merging of lanes based on a difference between a lateral position of a point on the road boundary 1503 and a lateral position of the at least one road structure 1505 in a specific frame being less than a preset value, a maximum longitudinal position value of the longitudinal position values of the road boundary 1503 decreasing over time, or a minimum longitudinal position value of the longitudinal position values of the at least one road structure 1505 decreasing over time. Accordingly, the processor of the object recognition apparatus may identify a merging section.

According to an example, the processor of the object recognition apparatus may identify that the road boundary 1503 has disappeared. Accordingly, the processor of the object recognition apparatus may obtain a first time point at which the merging is identified, and a second time point at which a specified time period has been elapsed after the time point at which at least one road structure 1505 with a size smaller than a specified size is not identified. During the time period from the first time point to the second time point, the processor of the object recognition apparatus may identify a region between a line corresponding to a lateral position of the at least one road structure and a lateral position spaced apart from the line by the width of the lane as a merging section.

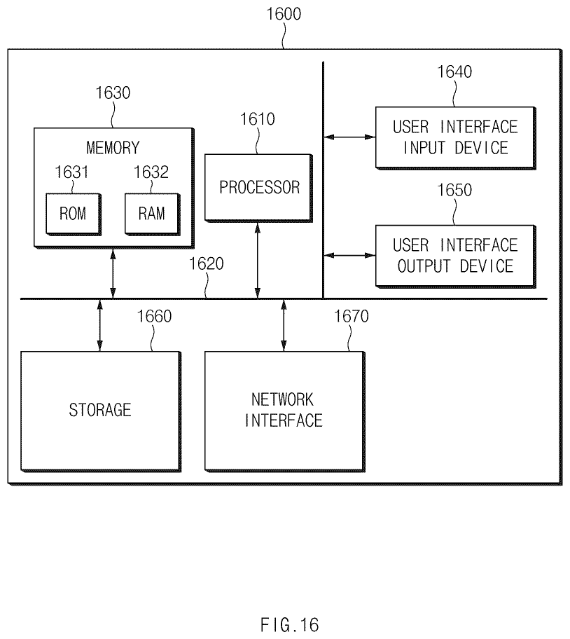

FIG. 16 shows an example of a computing system related to an object recognition apparatus and an object recognition method according to an example of the present disclosure.

Referring to FIG. 16, a computing system 1600 may include at least one processor 1610, a memory 1630, a user interface input device 1640, a user interface output device 1650, storage 1660, and a network interface 1670, which are connected with each other via a bus 1620.

The processor 1610 may be a central processing unit (CPU) or a semiconductor device that processes instructions stored in the memory 1630 and/or the storage 1660. The memory 1630 and the storage 1660 may include various types of volatile or non-volatile storage media. For example, the memory 1630 may include a ROM (Read Only Memory) 1631 and a RAM (Random Access Memory) 1632.

Thus, the operations of the method or the algorithm described in connection with the examples disclosed herein may be made directly in hardware or a software module executed by the processor 1610, or in a combination thereof. The software module may reside on a storage medium (that is, the memory 1630 and/or the storage 1660) such as a RAM, a flash memory, a ROM, an EPROM, an EEPROM, a register, a hard disk, a removable disk, and a CD-ROM.

The example storage medium may be coupled to the processor 1610, and the processor 1610 may read information out of the storage medium and may record information in the storage medium. Alternatively, the storage medium may be integrated with the processor 1610. The processor 1100 and the storage medium may reside in an application specific integrated circuit (ASIC). The ASIC may reside within a user terminal. In another case, the processor and the storage medium may reside in the user terminal as separate components.

The present disclosure has been made to solve the above-mentioned problems occurring in the prior art while advantages achieved by the prior art are maintained intact.

An example of the present disclosure provides an object recognition apparatus and method for identifying whether an object is a moving object or a stationary object that is able to be in a moving state.

An example of the present disclosure provides an object recognition apparatus and method for identifying whether an object is a moving object or a stationary object that is able to be in a moving state in a lane with a merging section.

An example of the present disclosure provides an object recognition apparatus and method for improving the accuracy of determination for identifying whether an object located in a specified range is a moving object or a stationary object that is able to be in a moving state.

An example of the present disclosure provides an object recognition apparatus and method for identifying a merging section by identifying a road boundary and a road structure.

An example of the present disclosure provides an object recognition apparatus and method for improving object tracking performance by identifying a merging section.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, an object recognition apparatus includes a sensor (e.g., LIDAR and a processor.

According to an example, the processor may identify a merging of two or more different lanes based on at least one of a lateral position of a point on a road boundary or a lateral position of at least one road structure, or any combination thereof, through the LIDAR, identify a merging section where there is a risk of an accident due to the merging, based on at least one of: whether the merging is identified, a specified time period, or a specified distance, or any combination thereof, and identify whether an object located in the merging section is a moving object, a stationary object that is able to be in a moving state, or an object that is unable to be in a moving state.

According to an example, the processor may identify the merging, based on at least one of a difference between the lateral position of the point on the road boundary corresponding to a longitudinal position of a host vehicle obtained through the LIDAR in a specific frame and the lateral position of the point on the road boundary in a frame after the specific frame, the lateral position of the at least one road structure having a size smaller than a specified size obtained through the LIDAR, or a longitudinal position of the at least one road structure, or any combination thereof. The point on the road boundary in the specific frame may be located in a same direction as a direction in which the point on the road boundary in the frame after the specific frame is located, with respect to the host vehicle.

According to an example, the processor may assign a reliability value indicating that an object obtained through the LIDAR and having a width smaller than a specified width and a length smaller than a specified length is a moving object or a stationary object that is able to be in a moving state to the object, and identify whether the object is a moving object, a stationary object that is able to be in a moving state, or an object that is unable to be in a moving state based on the reliability value.

According to an example, the processor may identify the merging based on a difference between the lateral position of the point on the road boundary in the specific frame and the lateral position of the point on the road boundary in the frame after the specific frame falling within a specified range, or a road boundary including the point on the road boundary in the specific frame being one of both lines of a lane in which the host vehicle is located, or any combination thereof. The specified range may include a range greater than a value according to a width of one lane and smaller than a value according to a width of a plurality of lanes.

According to an example, the processor may identify the merging of lanes based on at least one of a difference between the lateral position of the point on the road boundary and the lateral position of at least one of the at least one road structure in the specific frame being less than a preset value, a maximum longitudinal position value of longitudinal position values of the road boundary at which the point on the road boundary is located decreasing over time, or a minimum longitudinal position value of the longitudinal position values of the at least one road structure decreasing over time, or any combination thereof, if the at least one road structure and the point on the road boundary located in the same direction as the direction in which the at least one road structure is located with respect to the host vehicle are identified. The at least one of the at least one road structure may be located in the same direction as a direction in which the point on the road boundary in the specific frame is located, with respect to the host vehicle.

According to an example, the processor may identify the merging based on a minimum longitudinal position value among longitudinal position values of the at least one road structure decreasing over time if the at least one road structure is identified and the point on the road boundary located in the same direction as the direction in which the at least one road structure is located with respect to the host vehicle is not identified.

According to an example, the processor may identify the merging of lanes based on a difference between a lateral position of the road structure corresponding to the longitudinal position of the host vehicle among lateral positions of the at least one road structure, and the lateral position of the point on the road boundary located in the same direction as the direction in which the at least one road structure is located with respect to the host vehicle, being greater than a preset difference value based on a lane width if the at least one road structure is identified and the point on the road boundary located in the same direction as the direction in which the at least one road structure is located with respect to the host vehicle is identified.

According to an example, the processor may, if the merging is identified based on the at least one road structure, obtain a first time point at which the merging is identified, obtain a second time point at which the specified time period has been elapsed after a time point at which the at least one road structure is not identified, and identify a region between a line corresponding to the lateral position of the at least one road structure and a lateral position spaced apart from the line by the width of the lane as a merging section, during a time period from the first time point to the second time point.

According to an example, the processor may, if the merging is identified based on the difference between the lateral position on the point of the road boundary in the specific frame and the lateral position in the frame after the specific frame, obtain a third time point at which the merging is identified, obtain a fourth time point at which the host vehicle has traveled the specified distance, and identify a region between a line including the point on the road boundary in the specific frame and a road boundary including the point on the road boundary in the frame after the specific frame as the merging section, during a time period from the third time point to the fourth time point.

According to an example, the processor may store information in a frame after the frame in which the object is identified in the merging section in association with the object as history information based on the object being identified in the merging section.

According to an example, the processor may identify the object as not obscured by the road structure if the object located in the merging section is obscured by the road structure.

According to an example, a reliability value assigned to an object that is located in the merging section and has a width less than a specified width and a length less than a specified length may be larger than a reliability value assigned to an object that is not located in the merging section or has a width greater than the specified width or a length greater than the specified length.

According to an example of the present disclosure, an object recognition method includes identifying a merging of two or more different lanes based on at least one of a lateral position of a point on a road boundary or a lateral position of at least one road structure, or any combination thereof, through a LIDAR, identifying a merging section where there is a risk of an accident due to the merging, based on at least one of: whether the merging is identified, a specified time period, or a specified distance, or any combination thereof, and identifying whether an object located in the merging section is a moving object, a stationary object that is able to be in a moving state, or an object that is unable to be in a moving state.

According to an example, the identifying of the merging of two or more different lanes based on the at least one of the lateral position of the point on the road boundary or the lateral position of the at least one road structure, or any combination thereof, through the LIDAR may include identifying the merging, based on at least one of a difference between the lateral position of the point on the road boundary corresponding to a longitudinal position of a host vehicle obtained through the LIDAR in a specific frame and the lateral position of the point on the road boundary in a frame after the specific frame, the lateral position of the at least one road structure having a size smaller than a specified size obtained through the LIDAR, or a longitudinal position of the at least one road structure, or any combination thereof. The point on the road boundary in the specific frame may be located in a same direction as a direction in which the point on the road boundary in the frame after the specific frame is located, with respect to the host vehicle.

According to an example, the identifying of whether the object located in the merging section is the moving object, the stationary object that is able to be in the moving state, or the object that is unable to be in the moving state may include assigning a reliability value indicating that an object obtained through the LIDAR and having a width smaller than a specified width and a length smaller than a specified length is a moving object or a stationary object that is able to be in a moving state to the object, and identifying whether the object is a moving object, a stationary object that is able to be in a moving state, or an object that is unable to be in a moving state based on the reliability value.

According to an example, the identifying of the merging of two or more different lanes based on the at least one of the lateral position of the point on the road boundary or the lateral position of the at least one road structure, or any combination thereof, through the LIDAR may include identifying the merging based on a difference between the lateral position of a point on a road boundary in the specific frame and the lateral position of the point on the road boundary in the frame after the specific frame falling within a specified range; or a road boundary including the point on the road boundary in the specific frame being one of both lines of a lane in which the host vehicle is located, or any combination thereof. The specified range may include a range greater than a value according to a width of one lane and smaller than a value according to a width of a plurality of lanes.

According to an example, the identifying of the merging of two or more different lanes based on the at least one of the lateral position of the point on the road boundary or the lateral position of the at least one road structure, or any combination thereof, through the LIDAR may include identifying the merging of lanes based on at least one of a difference between the lateral position of the point on the road boundary and the lateral position of at least one of the at least one road structure in the specific frame being less than a preset value, a maximum longitudinal position value of longitudinal position values of the road boundary at which the point on the road boundary is located decreasing over time, or a minimum longitudinal position value of the longitudinal position values of the at least one road structure decreasing over time, or any combination thereof, if the at least one road structure and the point on the road boundary located in the same direction as the direction in which the at least one road structure is located with respect to the host vehicle are identified. The at least one of the at least one road structure may be located in the same direction as a direction in which the point on the road boundary in the specific frame is located, with respect to the host vehicle.

According to an example, the identifying of the merging of two or more different lanes based on the at least one of the lateral position of the point on the road boundary or the lateral position of the at least one road structure, or any combination thereof, through the LIDAR may include identifying the merging based on a minimum longitudinal position value among longitudinal position values of the at least one road structure decreasing over time if the at least one road structure is identified and the point on the road boundary located in the same direction as the direction in which the at least one road structure is located with respect to the host vehicle is not identified.

According to an example, the identifying of the merging of two or more different lanes based on the at least one of the lateral position of the point on the road boundary or the lateral position of the at least one road structure, or any combination thereof, through the LIDAR may include identifying the merging of lanes based on a difference between a lateral position of the road structure corresponding to the longitudinal position of the host vehicle among lateral positions of the at least one road structure, and the lateral position of the point on the road boundary located in the same direction as the direction in which the at least one road structure is located with respect to the host vehicle, being greater than a preset difference value based on a lane width, if the at least one road structure is identified and the point on the road boundary located in the same direction as the direction in which the at least one road structure is located with respect to the host vehicle is identified. According to an example, the identifying of the merging section where there is the risk of the accident due to the merging, based on at least one of: whether the merging is identified, the specified time period, or the specified distance, or a combination thereof may include, if the merging is identified based on the at least one road structure, obtaining a first time point at which the merging is identified, obtaining a second time point at which the specified time period has been elapsed after a time point at which the at least one road structure is not identified, and identifying a region between a line corresponding to the lateral position of the at least one road structure and a lateral position spaced apart from the line by the width of the lane as a merging section, during a time period from the first time point to the second time point.

The above description is merely illustrative of the technical idea of the present disclosure, and various modifications and variations may be made without departing from the essential characteristics of the present disclosure by those skilled in the art to which the present disclosure pertains.

Accordingly, the example disclosed in the present disclosure is not intended to limit the technical idea of the present disclosure but to describe the present disclosure, and the scope of the technical idea of the present disclosure is not limited by the example. The scope of protection of the present disclosure should be interpreted by the following claims, and all technical ideas within the scope equivalent thereto should be construed as being included in the scope of the present disclosure.

The present technology provides an object recognition apparatus and method for identifying whether an object is a moving object or a stationary object that is able to be in a moving state.

The present technology provides an object recognition apparatus and method for identifying whether an object is a moving object or a stationary object that is able to be in a moving state in a lane with a merging section.

The present technology provides an object recognition apparatus and method for improving the accuracy of determination for identifying whether an object located in a specified range is a moving object or a stationary object that is able to be in a moving state.

The present technology provides an object recognition apparatus and method for identifying a merging section by identifying a road boundary and a road structure.

The present technology provides an object recognition apparatus and method for improving object tracking performance by identifying a merging section.

In addition, various effects may be provided that are directly or indirectly understood through the disclosure.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus for controlling autonomous driving of a vehicle, the apparatus comprising:
a sensor; and
a processor,
wherein the processor is configured to:
determine, based on the sensor sensing at least one of a lateral position of a point on a road boundary or a lateral position of at least one road structure, a merging of at least two different lanes;
determine, based on at least one of a time period associated with the merging or a distance associated with the merging, a merging section associated with a risk of an accident;
determine a type of an object located in the merging section, wherein the type is one of a moving object, a first stationary object that is able to be in a moving state, or a second stationary object that is unable to be in a moving state; and
generate, based on the type of the object, a control signal for controlling the autonomous driving of the vehicle in the merging section.

2. The apparatus of claim 1, wherein the processor is configured to determine the merging, based on at least one of:
a difference between:
the lateral position of the point on the road boundary in a first frame, wherein the lateral position of the point on the road boundary in the first frame corresponds to a longitudinal position of the vehicle in the first frame and
the lateral position of the point on the road boundary in a second frame,
wherein the second frame is after the first frame;
the lateral position of the at least one road structure, wherein the at least one road structure has a size smaller than a threshold size; or
a longitudinal position of the at least one road structure, and
wherein the lateral position of the point on the road boundary in the first frame is located in a same direction as a direction in which the lateral position of the point on the road boundary in the second frame is located, relative to a position of the vehicle.

3. The apparatus of claim 1, wherein the processor is configured to:
assign, based on the sensor sensing a width and a length of an object and based on the width being smaller than a threshold width and the length being smaller than a threshold length, a reliability value indicating that the type of the object is the moving object or the first stationary object; and
determine, based on the reliability value, whether the type of the object is the moving object, the first stationary object or the second stationary object.

4. The apparatus of claim 2, wherein the processor is configured to determine the merging based on:
a difference between
the lateral position of the point on the road boundary in the first frame and
the lateral position of the point on the road boundary in the second frame, wherein the lateral position of the point on the road boundary in the second frame falls within a range, or
a road boundary comprising the point on the road boundary in the first frame, wherein the road boundary comprising the point on the road boundary in the first frame is one of both lines of a lane in which the vehicle is located,
wherein the range is greater than a value of a width of one lane and smaller than a value of a width of a plurality of lanes.

5. The apparatus of claim 2, wherein the processor is configured to determine the merging based on at least one of:
a difference between:
the lateral position of the point on the road boundary in the first frame and
the lateral position of the at least one road structure, wherein the lateral position of the at least one road structure is in the first frame and a lateral position value of the lateral position of the at least one road structure in the first frame is less than a preset value,
a maximum longitudinal position value of longitudinal position values of the road boundary at which the point on the road boundary is located, wherein the longitudinal position values of the road boundary are decreasing over time, or
a minimum longitudinal position value of longitudinal position values of the at least one road structure, wherein the longitudinal position values of the at least one road structure are decreasing over time, wherein the at least one road structure and the lateral position of the point on the road boundary in the first frame are located in a same direction as a direction in which the at least one road structure is located, relative to the position of the vehicle, and
wherein the at least one road structure is located in a same direction as a direction in which the lateral position of the point on the road boundary in the first frame is located, relative to the position of the vehicle.

6. The apparatus of claim 2, wherein the processor is configured to determine the merging based on a minimum longitudinal position value among longitudinal position values of the at least one road structure, wherein the longitudinal position values of the at least one road structure are decreasing over time, wherein the at least one road structure is determined and the lateral position of the point on the road boundary in the first frame is not located in the same direction as the direction in which the at least one road structure is located, relative to the position of the vehicle.

7. The apparatus of claim 2, wherein the processor is configured to determine the merging based on a difference between:
a lateral position of a plurality of lateral positions of the at least one road structure, wherein the lateral position of the at least one road structure corresponds to the longitudinal position of the vehicle, and
the lateral position of the point on the road boundary in the first frame, wherein the lateral position of the point on the road boundary in the first frame is located in a same direction as a direction in which the at least one road structure is located, relative to the position of the vehicle, wherein the difference is greater than a threshold difference value, wherein the threshold difference value is preset based on a lane width, and wherein the at least one road structure is determined.

8. The apparatus of claim 1, wherein the processor is configured to:
obtain a first time point at which the merging is determined;
obtain a second time point at which the time period has been elapsed after a time point at which the at least one road structure is not determined; and
determine, based on the time period, a region between:
a line corresponding to the lateral position of the at least one road structure and
a lateral position spaced apart from the line by a width of a lane, wherein the region is determined as the merging section.

9. The apparatus of claim 2, wherein the processor is configured to:
obtain a third time point at which the merging is determined;
obtain a fourth time point at which the vehicle has traveled the distance; and
determine, based on the third time point and the fourth time point, a region between:
a line comprising the point on the road boundary in the first frame and
a road boundary comprising the point on the road boundary in the second frame, wherein the region is determined as the merging section.

10. The apparatus of claim 2, wherein the processor is configured to store, based on the object being in the merging section in the second frame, information in a third frame as history information.

11. The apparatus of claim 1, wherein the processor is configured to determine the object as not being obscured by the at least one road structure, based on the object being located in the merging section and obscured by the at least one road structure.

12. The apparatus of claim 3, wherein a reliability value, assigned to an object that is located in the merging section and has a width less than the threshold width and a length less than the threshold length, is larger than another reliability value assigned to a second object, wherein the second object is not located in the merging section or has a width greater than the threshold width or a length greater than the threshold length.

13. A method performed by a processor for controlling autonomous driving of a vehicle, the method comprising:
determining, based on a sensor sensing at least one of a lateral position of a point on a road boundary or a lateral position of at least one road structure, a merging of at least two different lanes;
determining, based on at least one of a time period associated with the merging or a distance associated with the merging, a merging section associated with a risk of an accident;
determining a type of an object located in the merging section, wherein the type is one of a moving object, a first stationary object that is able to be in a moving state, or a second stationary object that is unable to be in a moving state; and
generating, based on the type of the object, a control signal for controlling the autonomous driving of the vehicle in the merging section.

14. The method of claim 13, wherein the determining the merging is based on the at least one of:
a difference between the lateral position of the point on the road boundary in a first frame, wherein the lateral position of the point on the road boundary in the first frame corresponds to a longitudinal position of the vehicle in the first frame, and the lateral position of the point on the road boundary in a second frame, wherein the second frame is after the first frame;
the lateral position of the at least one road structure, wherein the at least one road structure has a size smaller than a threshold size, or
a longitudinal position of the at least one road structure, and
wherein the lateral position of the point on the road boundary in the first frame is located in a same direction as a direction in which the lateral position of the point on the road boundary in the second frame is located, relative to a position of the vehicle.

15. The method of claim 13, wherein the determining the type of the object comprises:
assigning, based on the sensor sensing a width and a length of an object and based on the width being smaller than a threshold width and the length being smaller than a threshold length, a reliability value indicating that the type of the object is the moving object or the first stationary object; and
determining, based on the reliability value, whether the type of the object is the moving object, the first stationary object, or the second stationary object.

16. The method of claim 14, wherein the determining the merging is based on:
a difference between the lateral position of the point on the road boundary in the first frame and the lateral position of the point on the road boundary in the second frame, wherein the lateral position of the point on the road boundary in the second frame falls within a range; or
a road boundary comprising the point on the road boundary in the first frame, wherein the road boundary comprising the point on the road boundary in the first frame is one of both lines of a lane in which the vehicle is located, and
wherein the range is greater than a value of a width of one lane and smaller than a value of a width of a plurality of lanes.

17. The method of claim 14, wherein the determining the merging is based on at least one of:
a difference between the lateral position of the point on the road boundary in the first frame and the lateral position of the at least one road structure, wherein the lateral position of the at least one road structure is in the first frame and a lateral position value of the lateral position of the at least one road structure in the first frame is less than a preset value,
a maximum longitudinal position value of longitudinal position values of the road boundary at which the point on the road boundary is located, wherein the longitudinal position values of the road boundary are decreasing over time, or
a minimum longitudinal position value of longitudinal position values of the at least one road structure, wherein the longitudinal position values of the at least one road structure are decreasing over time, wherein the at least one road structure and the lateral position of the point on the road boundary in the first frame are located in a same direction as a direction in which the at least one road structure is located, relative to the position of the vehicle, and
wherein the at least one road structure is located in a same direction as a direction in which the lateral position of the point on the road boundary in the first frame is located, relative to the position of the vehicle.

18. The method of claim 14, wherein the determining the merging is based on a minimum longitudinal position value among longitudinal position values of the at least one road structure, wherein the longitudinal position values of the at least one road structure are decreasing over time, wherein the at least one road structure is determined and the lateral position of the point on the road boundary in the first frame is not located in the same direction as the direction in which the at least one road structure is located, relative to the position of the vehicle.

19. The method of claim 14, wherein the determining the merging is based on a difference between:
a lateral position a plurality of lateral positions of the at least one road structure, wherein the lateral position of the at least one road structure corresponds to the longitudinal position of the vehicle and
the lateral position of the point on the road boundary in the first frame, wherein the lateral position of the point on the road boundary in the first frame is located in a same direction as a direction in which the at least one road structure is located, relative to the position of the vehicle,
wherein the difference is greater than a threshold difference value, wherein the threshold difference value is preset based on a lane width, and
wherein the at least one road structure is determined.

20. The method of claim 13, wherein the determining the merging section comprises:
obtaining a first time point at which the merging is determined;
obtaining a second time point at which the time period has been elapsed after a time point at which the at least one road structure is not determined; and
determining, based on the time period, a region between a line corresponding to the lateral position of the at least one road structure and a lateral position spaced apart from the line by a width of a lane, wherein the region is determined as the merging section.
